(19) United States
(12) Patent Application Publication
(10) Pub. No.: US 2008/0293382 A1
(43) Pub. Date: Nov. 27, 2008

(54) AUTHENTICATING FEMTOCELL-CONNECTED MOBILE DEVICES

(75) Inventors: Zeev V. Lubenski, Richardson, TX (US); Ojas Thakor Choksi, Herndon, VA (US); Pulin R. Patel, McKinney, TX (US); Michael Brett Wallis, McKinney, TX (US)

Correspondence Address: FISH & RICHARDSON P.C., P.O. BOX 1022, MINNEAPOLIS, MN, 55440-1022, US

(73) Assignee: MAVENIR SYSTEMS, INC., Richardson, TX (US)

(21) Appl. No.: 12/120,014

(22) Filed: May 13, 2008

Related U.S. Application Data
(60) Provisional application No. 60/939,823, filed on May 23, 2007.

(51) Int. Cl. H04M 1/66; H04M 1/00

(52) U.S. Cl. 455/411; 455/561

(57) ABSTRACT

The present disclosure includes a method and system for authenticating femtocell-connected mobile devices. In some implementations, a method includes receiving information associated with an authentication request transmitted by a cellular core network. The information is internetworked between a cellular radio technology and Session Initiation Protocol (SIP) for authenticating a cellular device in a femtocell.

### CLAIM OF PRIORITY

This application claims priority under 35 USC § 119(e) to U.S. Patent Application Ser. No. 60/939,823, filed on May 23, 2007, the entire contents of which are hereby incorporated by reference.

### TECHNICAL FIELD

This invention relates to communication networks and, more particularly, to authenticating femtocell-connected mobile devices.

### BACKGROUND

Communication networks include wired and wireless networks. Example wired networks include the Public Switched Telephone Network (PSTN) and the Internet. Example wireless networks include cellular networks as well as unlicensed wireless networks that connect to wire networks. Calls and other communications may be connected across wired and wireless networks.

Cellular networks are radio networks made up of a number of radio cells, or macrocells, that are each served by a base station or other fixed transceiver. The macrocells are used to cover different areas in order to provide radio coverage over a wide area. When a cell phone moves from place to place, it is handed off from macrocell to macrocell to maintain a connection. The handoff mechanism differs depending on the type of cellular network. Example cellular networks include Universal Mobile Telecommunications System (UMTS), Wide-band Code Division Multiple Access (WCDMA), and CDMA2000. Cellular networks communicate in a radio frequency band licensed and controlled by the government.

### SUMMARY

The present disclosure includes a method and system for authenticating femtocell-connected mobile devices. In some implementations, a method includes receiving information associated with an authentication request transmitted by a cellular core network. The information is internetworked between a cellular radio technology and the Session Initiation Protocol (SIP) for authenticating a cellular device in a femtocell.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating a communication system in accordance with some embodiments of the present disclosure;

FIGS. 2A to 2C illustrate call flows for authenticating a femtocell-connected mobile device in the communication system of FIG. 1; and

FIGS. 3A and 3C are flow charts illustrating example flow charts for internetworking authentication information in the system of FIG. 1.

### DETAILED DESCRIPTION

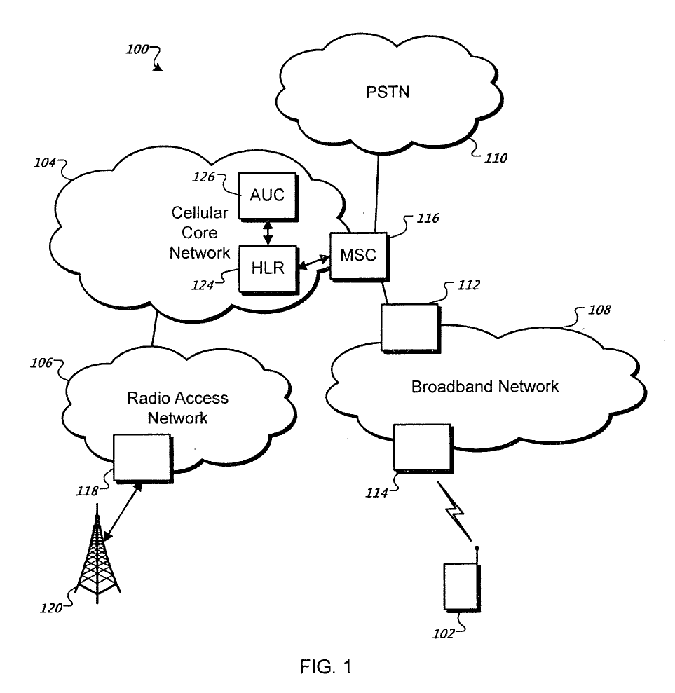

FIG. 1 illustrates a communication system 100 for internetworking authentication information in accordance with some embodiments of the present disclosure. For example, the system 100 may internetwork an authentication request to a broadband message. In general, femtocell devices include devices that wirelessly communicate cellular radio technologies within a geographic region, i.e., a femtocell, to enable communications sessions with a cellular device through Internet Protocol (IP) networks. In some implementations, the associated femtocell includes a range of 100 meters (m) to 200 m and transmit at a power less than or equal to 1 Watt (W). Cellular radio technologies include Global System for Mobile Communication (GSM) protocols, Code Division Multiple Access (CDMA) protocols, Universal Mobile Telecommunications System (UMTS), and/or any other suitable protocol for formatting data for cellular communication. Typically, the cellular radio technologies are associated with a Radio Access Network (RAN) that wirelessly communicate cellular radio technologies within a geographic region, i.e., a macrocell. In some implementations, the range of a macrocell is 10 to 1000 times greater than a femtocell. For example, a macrocell may cover 10 miles while a femtocell may cover 100 ft. In some implementations, the system 100 internetworks cellular radio technologies and Session Initiation Protocol (SIP) to authenticate mobile devices in a femtocell. For example, the system 100 may receive an authentication request from a cellular core network and map the authentication request to a SIP message for transmission through an Internet Protocol (IP) network to a femtocell device.

At a high level, system 100 includes mobile devices 102, cellular core network 104, Radio Access Network (RAN) 106, IP network 108, Public Switch Telephone Network (PSTN) 110, communication node 112, and femtocell device 114. Each mobile device 102 comprises an electronic device operable to receive and transmit wireless communication with system 100. As used in this disclosure, mobile devices 102 are intended to encompass cellular phones, data phones, pagers, portable computers, smart phones, personal data assistants (PDAs), one or more processors within these or other devices, or any other suitable processing devices capable of communicating information using cellular radio technology. In the illustrated embodiment, mobile devices 102 are able to transmit in the cellular band. In these cases, messages transmitted and/or received by mobile device 102 are based on a cellular radio technology. There may be any number of mobile devices 102 communicably coupled to RAN 106. Generally, the mobile devices 102 may transmit voice, video, multimedia, text, web content or any other user/client-specific content. In short, device 102 generates requests, responses or otherwise communicates with mobile core networks 104 through RANs 106 and/or IP network 108 via femtocells. In some implementations, the mobile device 102 can include a Subscriber Identity Module (SIM). For example, a SIM card may encrypt voice and data transmissions and store data about a specific user so that the user can be identified and authenticated to mobile core network 104. In some embodiments, a SIM card may comprise a Universal Subscriber Identity Module (USIM). In general, a SIM card is typically a smart card that securely stores the key identifying a mobile phone service subscriber, as well as subscription information, preferences, text messages and/or other information. In addition to storing authentication information, a SIM card may store network state information such as the location area identity (LAI). In response to receiving an authentication request from the mobile core network 104, the SIM, in some implementations, can use a random number (RAND) and In the example of the A3 algorithm method of encryption, the mobile core network 104 may provide the communication node 112 with a random number (RAND) and an encryption key Ki to a signature response (SRES). For example, the SIM may use an A3 algorithm to generate the SRES based, at least in part, on the RAND and the Ki. As discussed in more detail below, the mobile core network 104 compares the SRES generated by the mobile device 102 to an SRES generated by the mobile core network for authentication.

The cellular core network 104 typically includes various switching elements and gateways for providing cellular services. Cellular core network 104 often provides these services via a number of RANs, such as RAN 106, and also interfaces the cellular system with other communication systems such as PSTN 110 via mobile switching center (MSC) 116. In accordance with the GSM standard, cellular core network 104 includes a circuit switched (or voice switching) portion for processing voice calls and a packet switched (or data switching) portion for supporting data transfers such as, for example, e-mail messages and web browsing. The circuit switched portion includes MSC 116 that switches or connects telephone calls between RAN 106 and PSTN 110 or other network. The packet-switched portion, also known as General Packet Radio Service (GPRS), includes a Serving GPRS Support Node (SGSN) (not illustrated), similar to MSC 116, for serving and tracking mobile devices 102, and a Gateway GPRS Support Node (GGSN) (not illustrated) for establishing connections between packet-switched networks and mobile devices 102. The SGSN may also contain subscriber data useful for establishing and handing over call connections. Cellular core network 104 may also include a home location register (HLR) 124 for maintaining “permanent” subscriber data and a visitor location register (VLR) (and/or a SGSN) for “temporarily” maintaining subscriber data retrieved from the HLR and up-to-date information on the location of mobile devices 102, and Authentication Center (AUC) 126. The HLR 124 contains a database of GSM subscriber data. The HLR 124 may also contain information regarding which services each user has subscribed to. In addition, the HLR 124 may be used to track the billing of each user within the mobile core network 104. The HLR 124 references the AUC 126 by the subscriber's IMSI, which acts as a subscriber record identification number, to retrieve authentication data when a user is attempting connection to mobile core network 104. The AUC 126 generates authentication data based on a stored Ki which is held both by the mobile device 102, typically within its SIM card, and the AUC 126. This authentication data is used by the MSC 116 to authenticate users. Once a user has been authenticated, the AUC 126 stores the active subscriber's authentication key. In some implementations, the cellular core network 104 may use standard GSM authentication procedures, for example by using the A3, A5, or A8 encryption algorithm or a combination of these.

PSTN 110 comprises a circuit-switched network that provides fixed telephone services. A circuit-switched network provides a dedicated, fixed amount of capacity (a “circuit”) between the two devices for the duration of a transmission session. In general, PSTN 110 may transmit voice, other audio, video, and data signals. In transmitting signals, PSTN 110 may use one or more of the following: telephones, key telephone systems, private branch exchange trunks, and certain data arrangements. Since PSTN 110 may be a collection of different telephone networks, portions of PSTN 110 may use different transmission media and/or compression techniques. Completion of a circuit in PSTN 110 between a call originator and a call receiver may require network signaling in the form of either dial pulses or multi-frequency tones.

RAN 106 provides a radio interface between mobile devices 102 and cellular core network 104 that may provide real-time voice, data, and multimedia services (e.g., a call) to mobile devices 102. In general, RAN 106 communicates air frames 112 via radio frequency (RF) links. In particular, RAN 106 converts between air frames to physical link based messages for transmission through cellular core network 104. RAN 106 may implement, for example, one of the following wireless interface standards during transmission: IS-54 (TDMA), Advanced Mobile Phone Service (AMPS), GSM standards, CDMA, Wideband CDMA (WCDMA) Time Division Multiple Access (TDMA), General Packet Radio Service (GPRS), ENHANCED DATA rates for Global EVOLUTION (EDGE), HSDPA, EVDO-Rev A. Worldwide Interoperability for Microwave Access (WIMAX), or proprietary radio interfaces.

RAN 106 may include Base Stations (BS) 114 connected to Base Station Controllers (BSC) 116. BS 118 receives and transmits air frames 112 within a geographic region of RAN 106 called a cell and communicates with mobile devices 102 in the cell. Each BSC 120 is associated with one or more BS 118 and controls the associated BS 118. For example, BSC 120 may provide functions such as handover, cell configuration data, control of RF power levels or any other suitable functions for managing radio resource and routing signals to and from BS 118. MSC 116 handles access to BSC 120 and communication node 112, which may appear as a BSC 120 to MSC 116. In some implementations, the communication node 112 may appear as another MSC to MSC 116. MSC 116 may be connected to BSC 120 through a standard interface such as the A-interface.

Network 108 facilitates wireline communication between femotcell device 114 and any other computer. As described, network 108 communicates IP packets to transfer voice, video, data, and other suitable information between network addresses. In communication sessions, network 108 can use the Session Initiation Protocol (SIP) to set up, route, and tear down sessions. SIP is an application layer control protocol for creating, modifying, and terminating communication sessions. The SIP protocol can provide support for a number of requests including INVITE, REGISTER, SUBSCRIBE, and NOTIFY. Network 108 may include one or more local area networks (LANs), metropolitan area networks (MANs), wide area networks (WANs), all or a portion of the global computer network known as the Internet, and/or any other communication system or systems at one or more locations. In the illustrated implementation, IP network 108 includes SIP proxy servers for routing SIP messages. Each SIP proxy server can be any software, hardware, and/or firmware operable to route SIP messages to other SIP proxies, gateways, SIP phones, femtocell device 114, nodes 112, and others. In some implementations, the SIP messages may encapsulate at least a portion of radio cellular technology and, as a result, the encapsulation can be transparent to standard SIP Proxy servers. In some cases, the radio cellular technology messages may be encapsulated in a Multipurpose Internet Mail Extension (MIME) body. The standard SIP proxy servers may only act on the standard SIP headers for routing/forwarding decisions of the SIP message and ignore encapsulations in the message body content header.

The femtocell device 114 can include any software, hardware, and/or firmware operable to wirelessly communicate with mobile phones 102 using cellular messages and translate, map or otherwise convert between cellular messages and SIP messages. For example, the femtocell device 114 may convert between SIP and UMTS or GSM messages. In some implementations, the SIP messages based on the cellular messages may be routed through the IP network 108 using standard SIP processing. In some implementations, the femtocell device 114 may generate SIP messages and transmit the SIP messages to the communication node 112 via IP network 108 thereby tunneling radio cellular technology over the IP network 108. In addition, the femtocell device 114 may receive from the communication node 112 a SIP message encapsulating a cellular message and reconstruct the cellular message based, at least in part, on the SIP message. The femtocell device 114 may generate the SIP messages in response to a discovery process, a call session request received from mobile devices 102, a mobility request received from mobile devices 102, a location update, call origination, call termination, and/or any other suitable event. For example, the femotcell device 114 may receive an authentication response from the cellular device 102 and map the authentication response to a SIP message. As mentioned above, the femotcell device 120, in some implementations, transmits messages to communication nodes 112 using SIP. In doing so, the femtocell device 114 may perform one or more of the following functions when generating the SIP message: add parameters to a cellular message and/or SIP message, encapsulate at least a portion of the cellular message; and/or translate parameters associated with cellular messages and SIP parameters. In the case of reconstructing the cellular message, the femtocell device 114 may unencapsulate the portion of the cellular message and translate parameters from SIP parameters to cellular-radio-technology parameters. In some implementations, the femtocell device 114 adds parameters to the generate cellular message.

In regards to encapsulation, the femtocell device 114 may encapsulate a portion of the cellular message in an extension of a conventional SIP message. For example, the femtocell device 114 may add a multipart Multi-Purpose Internet Mail Extensions (MIME) to a standard SIP message with appropriate MIME headers. In some implementations, the femtocell device 114 encapsulates a GSM/UMTS Non-Access Stratum (NAS)/Layer 3 message in a MIME body of a SIP message. In some implementations, the femtocell device 114 encapsulates the entire GSM/UMTS Mobility Management (MM), Connection Management (CM), and NAS message in the MIME body. Turning to translation, in forming the headers of the SIP message, the femtocell device 114 may translate, map, or otherwise convert parameters from the cellular message to appropriate SIP parameters. For example, the femtocell device 114 generate a SIP INVITE indicating a call origination request. In addition, the femtocell device 114 may also convert SIP messages to cellular messages for transmission to cellular devices 102. In particular, the femtocell device 114 may unencapsulate the cellular message from the SIP extension. Also, the femtocell device 114 may translate or otherwise map SIP parameters to one or more cellular-radio-technology parameters. After the femtocell device 114 generates the cellular message, the femotcell device 114 wirelessly transmits the message to the mobile device 102.

In managing different communication technologies, the communication node 112 may convert between cellular and/or broadband technologies. For example, the communication node 112 may receive a SIP request from the mobile device 102 to access services from the cellular core network 104. In this case, the communication node 112 may convert the SIP request to a GSM request prior to transmitting the request to cellular core network. The conversion may include conversion between parameters of different communication technologies and/or bit conversion. In addition, the communication node 112 may, in one embodiment, emulate or otherwise represent itself as an element of the cellular core network 104. For example, the communication node 112 may emulate or otherwise represent itself as a BSC, MSC, a mobile device, or other elements of the cellular core network 104. In the case that communication node 112 emulates a BSC, the communication node 112 may be queried by the MSC 116 in the cellular core network 104 like any other BSC 120. In the case of communication node 112 emulating an MSC, the communication node 112 may query the BSC 118 and perform call management functions associated with MSCs (e.g., Mobility Management, Call Control, Services). In regards to authentication, the communication node 112 may receive an authentication request from the mobile core network 104 including a random number (RAND) used to generate a signature response (SRES). The A3 algorithm uses the RAND and the Ki to generate the SRES. In some implementations, the communication node 112 can translate the authentication request to SIP message (e.g., INVITE, NOTIFY) and forward the SIP message to the femtocell device 120. In some embodiments, the communication node 112 encapsulates at least a portion of the authentication request in an extension of the SIP message.

In one aspect of operation, the cellular device 102 transmits a cellular message (e.g., location update, call origination, call termination) within the femtocell to the femtocell device 114. In response to at least the cellular message, the femtocell device 114 maps the cellular message to a SIP message (e.g., REGISTER, INVITE, NOTIFY) for transmission through the IP network 108. The communication node 112 generates a cellular message based, at least in part, on the received SIP message and transmits to the cellular message to the mobile core network 104. In connection with the message transmitted by the cellular device 102, the core mobile network 104 transmits an authentication request to the communication node 112. In response to at least the request, the communication node 112 maps the authentication request including challenge parameters to a SIP message (e.g., SIP 407) and transmits the SIP message to the femtocell device 114 through the IP network 108. The femtocell device 114 maps the SIP message to the authentication message and wirelessly transmits the authentication request to the cellular device 102. Using the challenge parameters, the cellular device 102 generates an authentication response and transmits the response to the femtocell device 114. The femtocell device 114 maps the authentication response to a SIP response such as REGISTER, INVITE, or NOTIFY and transmits the SIP response to the communication node 112. The communication node 112 maps the SIP response to an authentication response including the challenge response. Based, at least in part, on the challenge response, the mobile core network 104 accepts or rejects authentication of the cellular device 102.

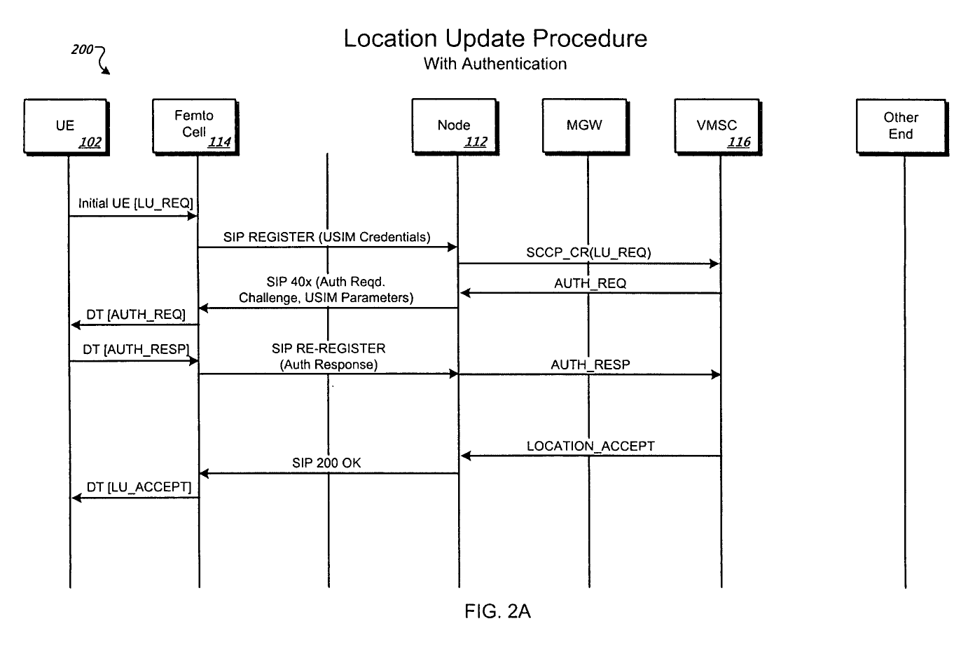

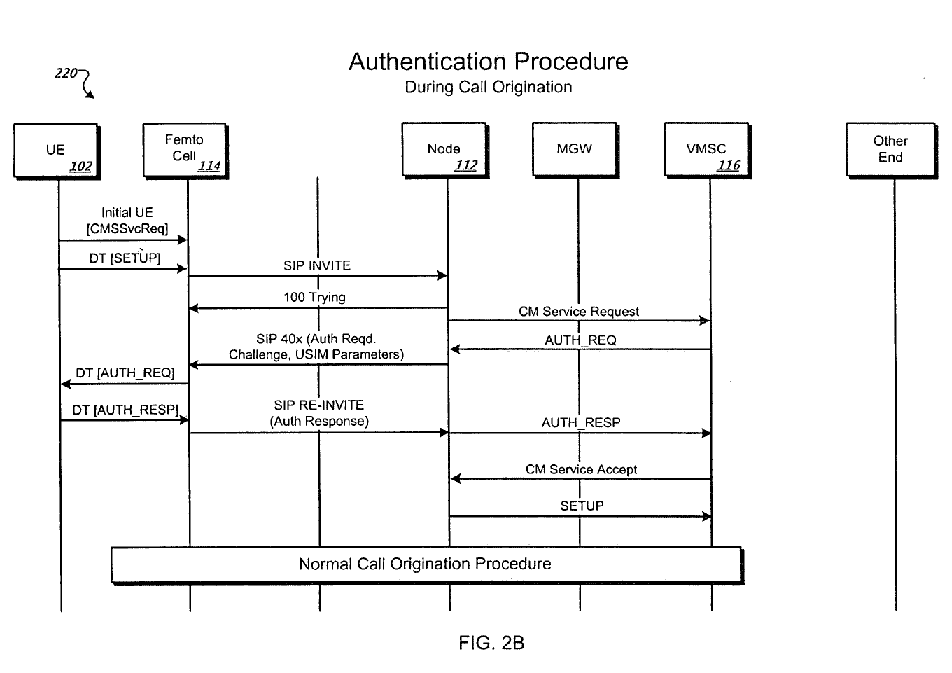

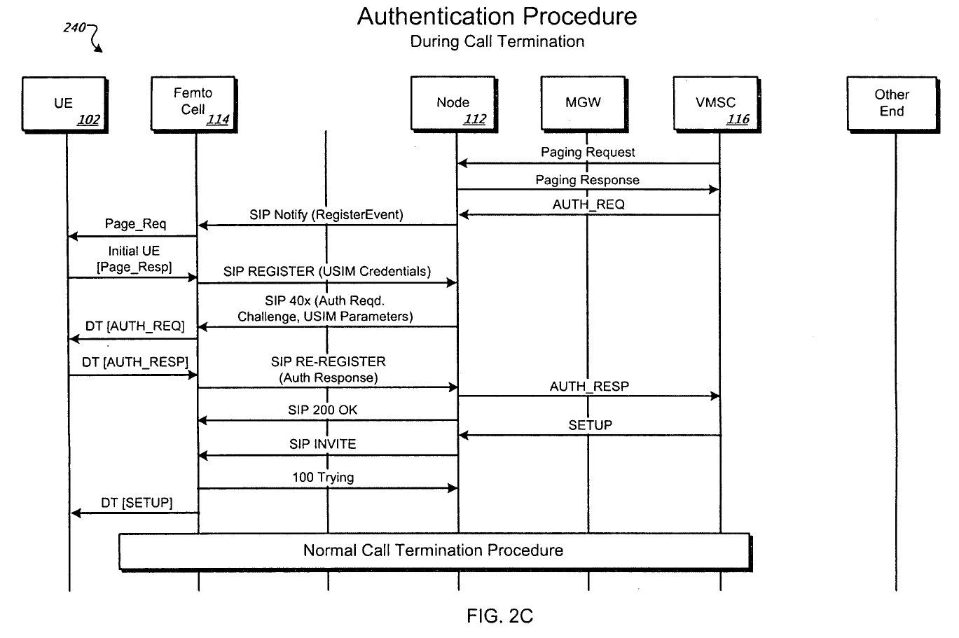

FIGS. 2A to 2C illustrate call flows 200, 220, and 240, respectively, in accordance with the system 100 of FIG. 1. In particular, flow 400 illustrates authenticating a cellular device 102 through the femtocell device 114 during a location update procedure. In the illustrated implementation, the mobile device 102 transmits a location update request to the femtocell device 114. The femtocell device 114 converts the location update request to a SIP REGISTER message that includes the USIM information. The communication node 112 converts an authentication request received from the cellular core network 104 to a SIP 40x message including the challenge parameters. Flow 420 illustrates authenticating cellular device 102 during a call origination. In the illustrated implementation, the mobile device 012 transmits call origination request to the femtocell device 114, which converts the origination request to a SIP INVITE. In connection with the origination request, the mobile core network 104 transmits an authentication request to the communication node 112, which converts the request to a SIP 40x including the challenge parameters (e.g., RAND). Flow 440 illustrates authenticating the cellular device 102 during a call termination.

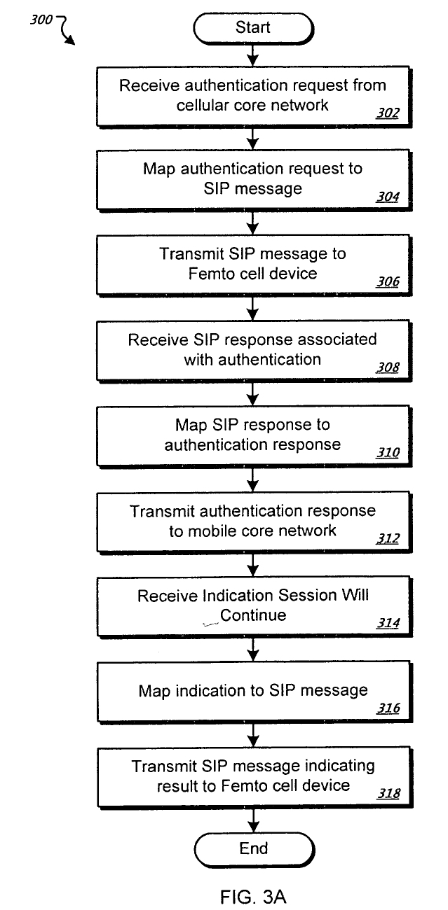

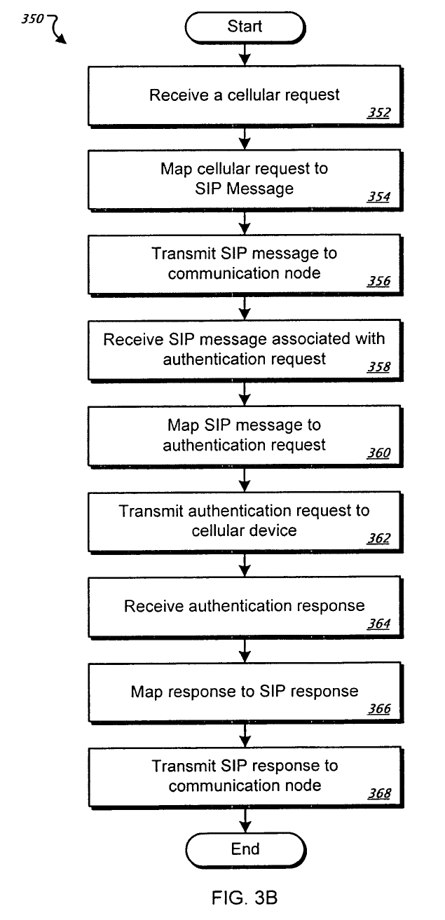

FIGS. 3A and 3B are a flow charts illustrating example methods 300 and 350 for internetworking authentication information in accordance with some implementations of the present disclosure. The illustrated methods are described with respect to system 100 of FIG. 1, but this method could be used by any other suitable system. Moreover, system 100 may use any other suitable techniques for performing these tasks. Thus, many of the steps in this flowchart may take place simultaneously and/or in different orders as shown. System 100 may also use methods with additional steps, fewer steps, and/or different steps, so long as the methods remain appropriate.

Referring to FIG. 3A, the method 300 begins at step 302 where an authentication request is received from a cellular core network in connection with a request from a cellular device. For example, the mobile core network 104 may transmit an authentication request to the communication node 112 in connection with a cellular request (e.g., location update, call origination, call termination). At step 304, the authentication request is mapped to a SIP message. In the example, the communication node 112 can map the authentication request to a SIP message such as a SIP 40x including challenge parameters (e.g., RAND). Next, at step 306, the SIP message is transmitted to a femtocell device. As for the example, the communication node 112 transmits the SIP message to the femtocell device 114 through the IP network 108. A SIP response associated with the authentication is received at step 308. In the example, the communication node 112 may receive a SIP response (e.g., INVITE, REGISTER) associated with an authentication response. At step 310, the SIP response is mapped to an authentication response including the challenge response (e.g., SRES). Returning to the example, the communication node 112 can generate an authentication response based, at least in part, on the SIP response. Next, at step 312, the authentication response is transmitted to the mobile core network. In the example, the communication node 112 can transmit the authentication response to the MSC 116. At step 314, an indication that the session will continue is received. The indication information is mapped to a SIP message at step 316. In the example, the communication node 112 maps the authentication result (e.g., location accept) to a SIP message such as SIP 200 OK, SIP INVITE, or others. At step 318, the SIP message is transmitted to the femtocell device indicating the results.

Referring to FIG. 3B, the method 350 begins at step 352 where a cellular request is received from a cellular device within a femtocell. For example, the cellular device 102 may transmit a location update request to the femtocell device 114. At step 304, the cellular request is mapped to a SIP message. In the example, the femtocell device 114 can map the update request to a SIP REGISTRATION. The SIP message is transmitted to a communication node associated with a cellular core network at step 306. In the example, the femtocell device 114 transmits the SIP REGISTRATION to the communication node 112. Next, at step 308, a SIP message associated with an authentication request is received. Returning to the example, the femtocell device 114 can receive a SIP 40x associated with an authentication request transmitted by the mobile core network 104. At step 310, the SIP message is mapped to an authentication request. As for the example, the femtocell device 114 maps the SIP 40x to an authentication request compatible with the cellular device 102. Next, at step 312, the authentication request is transmitted to the cellular device. An authentication response is received at step 314. In the example, the femtocell device 114 can receive an authentication response including an SRES. The authentication response is mapped to a SIP message at step 316 and transmitted to the communication node at step 318.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method, comprising:
receiving information associated with an authentication request transmitted by a cellular core network; and
internetworking the information between a cellular radio technology and Session Initiation Protocol (SIP) for authenticating a cellular device in a femtocell.

2. The method of claim 1, wherein the information comprises the authentication request.

3. The method of claim 2, wherein internetworking the information comprises mapping the authentication request to a SIP message for transmission through an Internet Protocol (IP) network.

4. The method of claim 3, wherein the SIP message comprises a SIP 40x message.

5. The method of claim 1, the information comprising a random number (RAND).

6. The method of claim 1, wherein the information comprises a signature response (SRES).

7. The method of claim 1, wherein receiving information associated with an authentication request comprises wirelessly receiving an authentication response from the cellular device the femtocell.

8. The method of claim 7, wherein internetworking the information comprises generating a SIP message based, at least in part, on the authentication response.

9. The method of claim 8, the SIP message comprising one of a SIP INVITE, a SIP SUBSCRIBE, a SIP NOTIFY, or a SIP REGISTER.

10. The method of claim 1, wherein the cellular radio technology comprises one of GSM, UMTS, WIMAX, WCDMA, EVDO, HSDPA, or CDMA.

11. The method of claim 1, wherein internetworking the information comprises encapsulating at least a portion of the information in a SIP message.

12. The method of claim 11, wherein the at least a portion is encapsulated in a MIME body.

13. A device, comprising:
a receiver configured to receive information associated with an authentication request transmitted by a cellular core network; and
a mapping module configured to internetwork the information between a cellular radio technology and Session Initiation Protocol (SIP) for authenticating a cellular device in a femtocell.

14. The device of claim 13, wherein the information comprises the authentication request.

15. The device of claim 14, wherein the mapping module configured to internetwork the information comprises the mapping module configured to map the authentication request to a SIP message for transmission through an Internet Protocol (IP) network.

16. The device of claim 15, wherein the SIP message comprises a SIP 40x message.

17. The device of claim 13, wherein the information comprises a random number (RAND).

18. The device of claim 13, wherein the information comprises a signature response (SRES).

19. The device of claim 13, wherein the receiver configured to receive information associated with an authentication request comprises the receiver configured to wirelessly receive an authentication response from the cellular device the femtocell.

20. The device of claim 19, wherein the mapping module configured to internetwork the information comprises the mapping module configured to generate a SIP message based, at least in part, on the authentication response.

21. The device of claim 20, wherein the SIP message comprises one of a SIP INVITE, a SIP SUBSCRIBE, a SIP NOTIFY, or a SIP REGISTER.

22. The device of claim 13, wherein the cellular radio technology comprises one of GSM, UMTS, WIMAX, WCDMA, EVDO, HSDPA, or CDMA.

23. The device of claim 13, wherein internetworking the information comprises encapsulating at least a portion of the information in a SIP message.

24. The device of claim 23, wherein the at least a portion is encapsulated in a MIME body.
